(19) United States
(12) Patent Application Publication
(10) Pub. No.: US 2026/0051246 A1
(43) Pub. Date: Feb. 19, 2026

(54) SECURE, SCALABLE NETWORKED V2X SYSTEM FOR BROADCASTING REAL-TIME SIGNAL PHASE AND TIMING (SPAT) DATA AND OTHER SAE J2735 STANDARD MESSAGES

(71) Applicant: BlueHalo Labs, LLC, Albuquerque, NM (US)

(72) Inventors: Mohammad Asadul Hoque, Rockville, MD (US); Ziyi Ma, Rockville, MD (US); Xiaoliang Zhao, Rockville, MD (US)

(21) Appl. No.: 19/301,803

(22) Filed: Aug. 15, 2025

Related U.S. Application Data
(60) Provisional application No. 63/684,197, filed on Aug. 16, 2024.

(51) Int. Cl. G08G 1/09; G08G 1/081; H04L 67/101; H04L 67/12; H04L 67/55

(52) U.S. Cl. CPC G08G 1/094; G08G 1/081; H04L 67/101; H04L 67/12; H04L 67/55

(57) ABSTRACT

A method and system for cloud-based V2X for providing real-time broadcast of signal phase and timing (SPaT) data. An example method includes receiving SPaT data from one or more traffic signal controllers, processing the SPaT data by converting the SPaT data from an original format into one or more different formats, where the processing includes distributing a processing load over a plurality of docker containers using a grouping or clustering algorithm that takes into account a raw data arrival sequence from the traffic signal controllers, determining one or more nearest intersections based on geolocation of a client device, and transmitting processed SPaT data related to at least one of the one or more nearest intersections to the client device.

### CROSS-REFERENCE TO RELATED APPLICATIONS

This application claims the benefit of and priority to U.S. Provisional Patent Application No. 63/684,197 filed on Aug. 16, 2024, the disclosure of which is hereby incorporated by reference in its entirety for all purposes.

### TECHNICAL FIELD

The present application relates generally to the field of vehicle-to-everything (V2X) communication technology. Specifically, the application pertains to a networked V2X system that leverages cloud computing infrastructure to enhance vehicle communication capabilities, improve traffic management, and ensure safer transportation by providing a secure, scalable and cost efficient alternative to Direct V2X technologies operating on 5.9 GHz frequency band for real-time broadcast of signal phase and timing data, MAP messages describing roadway intersection layout and other SAE J2735 messages.

### BACKGROUND OF THE DISCLOSURE

In recent years, advancements in wireless communication technologies and the proliferation of connected vehicles have led to the emergence of vehicle-to-everything (V2X) communication systems. V2X technology encompasses various forms of communication, including vehicle-to-vehicle (V2V), vehicle-to-infrastructure (V2I), vehicle-to-pedestrian (V2P), vehicle-to-network (V2N), etc. The overarching objective of V2X communication is to enhance road safety, optimize traffic efficiency, and improve the overall driving experience by enabling real-time information sharing and coordinated responses among diverse components of the transportation ecosystem.

The United States department of transportation (USDOT) has been striving to establish a national vision to enable a safe, efficient, equitable, and sustainable transportation system through the national, widespread deployment of interoperable V2X technologies. This effort has laid the foundation for the development of the draft national V2X deployment plan. The plan establishes a set of short-term, medium-term, and long-term deployment goals and targets to focus activity and coordinate stakeholder actions for making progress toward achieving the vision. Reaching these goals will depend on the coordinated actions of multiple stakeholders. So far, the nationwide deployments utilizing V2X technologies have demonstrated the benefits on a relatively smaller scale (e.g., within a county or a city). However, the full lifesaving potential of V2X technology will require a much larger scale deployment across the nation where vehicles and infrastructure can communicate reliably and securely across the jurisdiction boundaries through a variety of technologies, devices, platforms and communication media.

Traditional V2X systems have been relying heavily on dedicated short-range communication (DSRC) and cellular V2X (C-V2X) technologies, which have inherent limitations in terms of coverage, and scalability. These systems often struggle to manage large volumes of data generated by modem connected vehicles and the increasing number of smart infrastructure elements. Additionally, the rapid growth of autonomous driving technologies demands more robust, reliable and scalable communication frameworks to support complex decision-making processes and ensure the safety of autonomous vehicles.

To address these challenges, cloud-based networked V2X technology has emerged as a promising solution. By leveraging the computational power, storage capacity, and scalability of cloud computing infrastructure, networked V2X systems can efficiently process and analyze vast amounts of data in real-time. This enables more sophisticated and predictive traffic management solutions, enhanced vehicle coordination, and improved integration with other smart city technologies.

Almost all the existing nationwide V2X deployments rely on physical road-side units (RSUs) to enable the communication from the traffic light infrastructure through 5.9 GHz frequency bands. Recently, there have been some developments on cloud-based V2X technology that is still not explored thoroughly by the USDOT in terms of performance and benefits. The cloud-based V2X technologies have the potential to provide a flexible architecture to deploy virtual RSUs in the cloud as a cost-effective and scalable alternative to deploying physical RSUs at each intersection that can meet the low latency requirements (<100 ms) for safety critical applications. Most virtual RSUs leverage message queuing telemetry transport (MQTT) protocol for communication over transmission control protocol (TCP) packets and a cloud-based MQTT broker for high-frequency message interchanges between vehicles, traffic signals, and pedestrians.

Despite these advancements, existing cloud V2X implementations suffer from significant drawbacks. Some solutions are restricted to a single cellular operator's network, undermining interoperability. Other systems necessitate expensive edge devices and routers at every intersection, severely limiting cost-efficiency and scalability. Certain automotive applications, including those in commercial vehicles, experience unacceptably high latencies (2-6 seconds), rendering them unsuitable for real-time signal phase and timing (SPaT) broadcasting. Accordingly, there exists a need for a scalable, cost-effective, and low-latency cloud-based V2X system capable of delivering SPaT and other SAE J2735 standard messages in real time, thereby addressing the limitations of current solutions.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY OF THE DISCLOSURE

The present disclosure addresses deficiencies in existing solutions related to the most widely deployed V2X application in the United States, namely, the real-time broadcast of SPaT data in conjunction with MAP data (i.e., MAP message defined by the SAE J2735 standard). The disclosed system provides improvements in scalability, latency, and reliability, thereby overcoming limitations observed in current implementations.

According to one embodiment, a system for providing real-time broadcast of SPaT data includes one or more processors and memor(ies) coupled to the processors and configured to store executable instructions that, when executed by the processors, cause the processors to perform operations including receiving SPaT data from one or more traffic signal controllers in either NTCIP 1202 or SAE J2735 format; processing the SPaT data by converting the SPaT data into one or more different formats, where the processing includes distributing a processing load across a plurality of docker containers using a grouping or clustering algorithm that accounts for a raw data arrival sequence from the traffic signal controllers; digitally signing and verifying the processed data using third-party security credential management system (SCMS) API leveraging IEEE 1609.2 protocol; determining one or more nearest intersections based on geolocation data of a client device through a cloud-hosted REST API or other software interfaces; and transmitting the processed SPaT data corresponding to the one or more nearest intersections to the client device in an SAE defined format or other standard formats such as JSON, where data transmission is implemented over heterogeneous network links through a network including one or more of Ethernet, fiber, 5G, LTE, or satellite links, where a cloud-hosted scalable publish-subscribe based messaging broker including a message queuing telemetry transport (MQTT) broker is leveraged in one or more of data receiving, processing, verification, or transmission.

According to another embodiment, a method for providing real-time broadcast of SPaT data includes receiving SPaT data from one or more traffic signal controllers in either NTCIP 1202 or SAE J2735 format; processing the SPaT data by converting the SPaT data into one or more different formats, where the processing includes distributing a processing load across a plurality of docker containers using a grouping or clustering algorithm that accounts for a raw data arrival sequence from the traffic signal controllers; digitally signing and verifying the processed data using third-party SCMS API leveraging IEEE 1609.2 protocol; determining one or more nearest intersections based on geolocation data of a client device through a cloud-hosted REST API or other software interfaces; and transmitting the processed SPaT data corresponding to the one or more nearest intersections to the client device in an SAE defined format or other standard formats such as JSON, where data transmission is implemented over heterogeneous network links through a network including one or more of Ethernet, fiber, 5G, LTE, or satellite links, where a cloud-hosted scalable publish-subscribe based messaging broker including a message queuing telemetry transport (MQTT) broker is leveraged in one or more of data receiving, processing, verification, or transmission.

The foregoing is a summary and thus contains, by necessity, simplifications, generalizations, and omissions of detail; consequently, the summary is illustrative only and is not limiting in any way. Other aspects, inventive features, and advantages of the systems and/or processes described herein may become apparent in the non-limiting detailed description set forth herein.

### BRIEF DESCRIPTION OF THE DRAWINGS

These and other features, aspects, and advantages of the present disclosure may become better understood with regard to the following description, and accompanying drawings, where:

FIG. 1 shows a block diagram of a system architecture of a cloud-based V2X system, in accordance with some embodiments.

FIG. 2A shows an example user interface on a smartphone device depicting live SPaT data communicated through a cellular network, in accordance with some embodiments.

FIG. 2B shows an example user interface on a personal computer showing live SPaT data, in accordance with some embodiments.

FIG. 3 shows an example process flow for providing real-time broadcast of SPaT data by using cloud-based V2X, in accordance with some embodiments.

FIG. 4 is a block diagram of an example cloud-based V2X system for cloud processing, in accordance with some embodiments.

FIG. 5 is a block diagram of an example cloud-based V2X system for edge processing, in accordance with some embodiments.

FIG. 6 is a block diagram of an example cloud-based V2X system for on-site processing, in accordance with some embodiments.

FIG. 7 shows user interfaces captured from a smartphone and a tablet during a field test, in accordance with some embodiments.

FIGS. 8A-8C illustrate exemplary methods for determining an end-to-end latency in networked V2X systems, in accordance with some embodiments.

FIGS. 9A-9B shows some data obtained from latency tests conducted by two different smartphones in two different states, in accordance with some embodiments.

FIGS. 10A-10B are latency test data obtained from two different controllers within a state, in accordance with some embodiments.

FIG. 11 is a block diagram of an exemplary computing device for implementing the systems and methods described in reference to FIGS. 1-6, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure

### DETAILED DESCRIPTION

To make the aforementioned objects, features, and advantages of the present disclosure more obvious and understandable, the present disclosure may be further described below with reference to the accompanying drawings and embodiments.

It should be noted that specific details are set forth in the following description to fully understand the present disclosure. However, the present disclosure may be implemented in many other ways different from those described herein, and those skilled in the art may make similar generalizations without violating the connotation of the present disclosure. Therefore, the present disclosure is not limited by the specific embodiments disclosed below.

The terms used in the embodiments of the present disclosure are only for the purpose of describing specific embodiments and are not intended to limit the present disclosure. The singular forms of “a”, “said” and “the” used in the embodiments of the present disclosure and the appended claims are also intended to include plural forms, unless the context clearly indicates other meanings.

It should be noted that the example embodiments may be implemented in various forms, and should not be construed as being limited to the embodiments set forth herein. On the contrary, the provision of these embodiments makes the present disclosure more comprehensive and complete, and fully conveys the concept of the example embodiments to those skilled in the art. The same reference numerals in the figures indicate the same or similar structures, and thus their repeated description may be omitted. In addition, the similarities between the embodiments may not be repeated.

### Technical Objective and Benefits

To overcome the above described technical challenges in existing V2X systems, the present disclosure provides a scalable, low-latency cloud-based V2X system that employs dockerized container technology within a cloud infrastructure, enabling real-time processing and distribution of SPaT data compliant with SAE J2735 standards. This cloud-native architecture achieves end-to-end latency of less than 30 milliseconds, meeting or exceeding industry requirements for safety-critical vehicular communications.

One aspect of the solution is the replacement of physical RSUs with virtual RSUs hosted in the cloud, eliminating the need for costly edge devices at every intersection. This significantly reduces hardware and maintenance costs, making large-scale, cost-effective deployment feasible for transportation agencies.

In addition, the system's network-agnostic design allows seamless operation over any communication medium, including Ethernet, fiber optic networks, 4G LTE, 5G cellular, satellite links, or a combination thereof. This flexibility ensures easy integration with existing infrastructure, avoiding the constraints of vendor-specific solutions.

To address scalability and processing efficiency, the system incorporates an intelligent clustering algorithm that dynamically distributes the processing load based on the arrival sequence of SPaT data. This ensures optimal use of computational resources and minimizes processing delays even under high data loads from hundreds of thousands of intersections.

Further enhancing adaptability, the system supports multiple deployment models, including pure cloud processing, edge-assisted processing, and on-site processing. This enables agencies to tailor deployment strategies according to their technical capabilities and budgetary constraints.

Additionally, the solution disclosed herein includes a geolocation-driven data delivery mechanism using geohash-based REST APIs and MQTT brokers, ensuring that client devices receive location-relevant SPaT data in real-time, while reducing unnecessary data transmission (such as personal identifiable information) and improving system responsiveness.

Overall, the present disclosure provides a flexible, cost-effective, and highly scalable V2X solution that effectively resolves the key technical problems of latency, cost, scalability, and interoperability inherent in existing systems, providing a robust platform for modern connected transportation networks.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

### Overall System

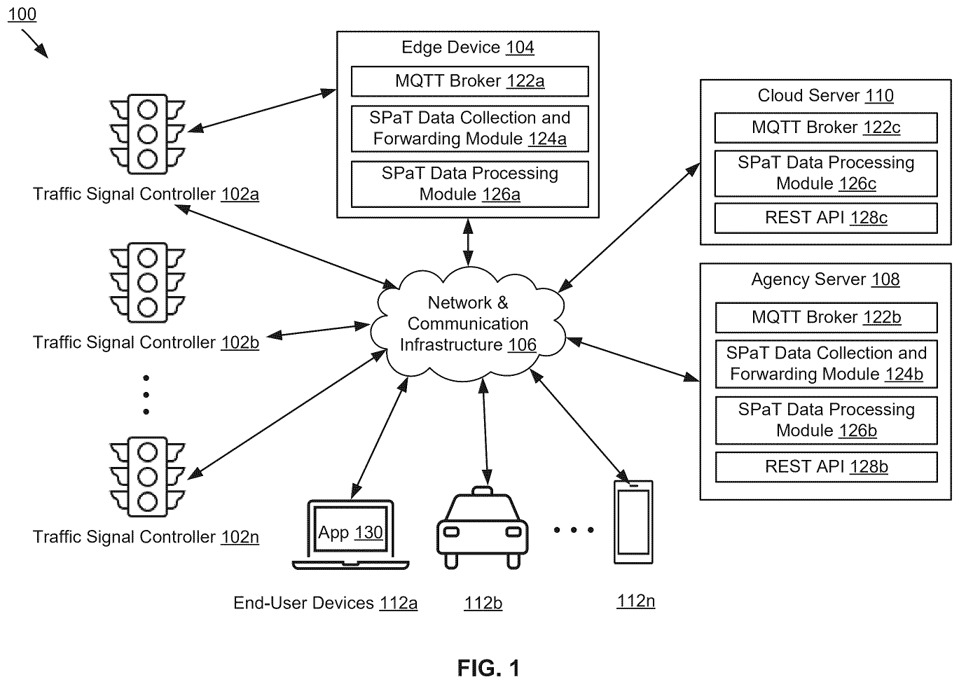

In the following, a cloud-based V2X system 100 is described with reference to specific hardware components and software components shown in FIG. 1. The exemplary hardware components may include, but are not limited to, a plurality of traffic signal controllers 102a, 102b, . . . , 102n (together or individually referred to as traffic signal controller 102 or traffic controller 102), one or more edge devices 104, a corresponding network and communication infrastructure 106, one or more agency servers 108 (together or individually referred to as agency server 108), a cloud computing node (or cloud server) 110, and one or more end-user devices (or client devices) 112a, 112b, 112c, . . . , (together or individually referred to as end-user device 1122 or client device 112). The exemplary software components may include, but are not limited to, one or more MQTT brokers 122a, 122b, 122c, . . . , (together or individually referred to as MQTT broker 122), one or more SPaT data collection and forwarding modules 124a, 124b, . . . , (together or individually referred to as SPaT data collection and forwarding module 124), one or more SPaT data processing modules 126a, 126b, 126c, . . . , (together or individually referred to as SPaT data processing module), one or more REST API 128b, 128c, . . . , (together or individually referred to REST API 128b) for geofencing and virtual signs, and one or more client applications 130.

A traffic signal controller 102 is a key component in the system architecture 100, responsible for managing the operational logic of traffic signals at various locations, including intersections, pedestrian crossings, and other controlled traffic points. The primary function of the traffic signal controller 102 is to alternate service between conflicting traffic movements, thereby ensuring the safe and efficient flow of vehicular and pedestrian traffic through precise timing and coordination of traffic light phases.

In addition to core signal control functionality, a traffic signal controller 102 may further include a user interface for operator configuration and control, communication connectors (such as serial ports, Ethernet, fiber, or wireless interfaces) for integration with external networks, and an appropriate power supply unit to maintain continuous operation. In certain configurations, the traffic signal controller 102 may also be equipped with vehicle detection and pedestrian detection sensors, providing additional data inputs that enhance adaptive traffic control strategies.

Within the cloud-based V2X system 100 (also referred to herein as “system 100”) disclosed herein, the traffic signal controller 102 serves as the primary source of SPaT data. Any commercially available traffic signal controller may be utilized within the system, provided that its firmware supports the broadcasting of SPaT data, which may follow, for example, NTCIP 1202 or equivalent communication protocols.

In one embodiment, each traffic intersection is equipped with a dedicated traffic signal controller 102. During normal operation, the traffic signal controllers 102 generate and broadcast real-time operational data, such as SPaT messages, which are then collected and forwarded to other components of the cloud-based V2X system 100 for processing, transformation, and dissemination to end-user devices 112.

In some embodiments, the SPaT data processing module 126 implements an assured green time mechanism for actuated signal movements by configuring the traffic signal controller to operate in coordination mode “yield” with concurrent pedestrian phases set to “rest-in-walk.” In this configuration, when a coordinated phase approaches termination, the system initiates pedestrian clearance (displaying “Don't Walk” or flashing hand indication) while the vehicular phase continues to display green for the duration of the pedestrian clearance interval. This pedestrian clearance period, typically lasting 6-7 seconds, serves as a guaranteed assured green time during which vehicles can safely traverse the intersection. The vehicular phase subsequently transitions to yellow interval only after the pedestrian clearance interval completes, ensuring that the fixed pedestrian clearance duration provides a predictable and communicable assured green period via SPaT messages.

The assured green time implementation leverages the rest-in-walk operation where the pedestrian clearance interval becomes a reliable timing element that may be transmitted to approaching connected vehicles. By utilizing the mandatory pedestrian clearance time as the assured green period, the system provides vehicles with advance knowledge of a guaranteed minimum green duration, enabling informed decision-making for red light violation warning applications and dilemma zone protection. This approach is particularly advantageous for actuated coordinated signals, as it creates a predictable green time window within otherwise variable durations of green intervals while maintaining proper pedestrian safety clearance requirements.

An edge device 104 is a computing resource positioned proximate to the source of data generation, e.g., located at or near a traffic intersection and situated at the periphery of a communication network, rather than within a centralized cloud infrastructure or data center. The principal function of the edge device 104 is to perform localized data collection and processing, with the objective of reducing transmission latency, minimizing network bandwidth consumption, and enhancing real-time decision-making capabilities.

In the cloud-based V2X system 100 disclosed herein, the inclusion of the edge device 104 is deployment-specific. In certain deployment configurations, particularly those referred to as edge processing deployments, the edge device 104 is utilized to process SPaT data locally before transmitting processed data upstream to the cloud and/or directly to client devices 112. In alternative deployment configurations, such as in full cloud processing or on-site agency network processing, use of edge devices 104 can be optional or unnecessary, which stands in contrast to existing V2X systems where edge devices 104 (e.g., dedicated RSUs or local compute nodes) are mandatory for SPaT data collection, processing and broadcasting.

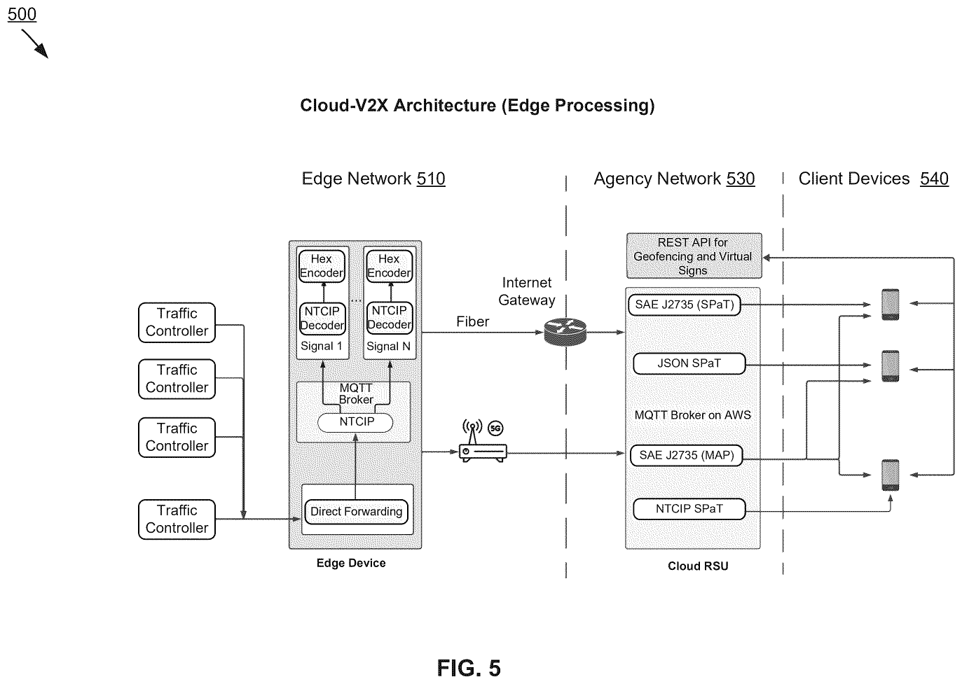

When an edge device 104 is incorporated into system 100 (e.g., for edge processing as shown in FIG. 5), it operates as a flexible and lightweight processing node, capable of running the SPaT data collection, transformation, and publication software. The edge device 104 requires minimal computational resources, and system 100 is designed to be hardware-agnostic, enabling deployment on cost-effective platforms such as Raspberry Pi single-board computers, NVIDIA Jetson embedded systems, or other commercially available small-form-factor computing devices. This flexibility ensures that local processing capabilities can be deployed efficiently and affordably, particularly in scenarios where network latency to cloud resources may be prohibitive.

The network and communication infrastructure 106 encompasses the various hardware components and communication interfaces utilized to facilitate the transmission of SPaT data and related V2X messages between traffic signal controllers 102, edge devices 104, agency server 108, cloud computing node 110, and client devices 112. This infrastructure includes, but is not limited to, serial ports, Ethernet connections, USB interfaces, cabinet wiring, cellular modems, fiber optic transceivers, wireless transceivers, Ethernet switches, and other data communication components.

In an example deployment, each traffic signal controller 102 is installed within a traffic cabinet, which may also house the networking equipment necessary for internal communication with traffic hardware and external communication with agency networks and cloud services. For instance, a standard configuration may involve a high-speed Ethernet switch providing an interface to a municipal or agency-managed backbone fiber network. Alternatively, a cellular modem provided within a cabinet may be employed to establish connectivity to external networks (such as agency networks) where fiber infrastructure is not available.

One of the features of the disclosed cloud-based V2X system 100 is its flexibility in communication infrastructure utilization. Unlike existing networked V2X systems, which mandate the deployment of a cellular modem within every traffic cabinet, the disclosed system 100 can seamlessly operate over either fiber or cellular networks, adapting to available communication resources at each deployment site. Additionally, system 100 supports shared communication pathways if the cellular communication infrastructure is utilized to push the SPaT data to the cloud, such that a single cellular modem, potentially located at a central node, can be used to serve multiple intersections interconnected via a fiber backbone. This arrangement eliminates the need for deploying modems in each cabinet, thereby reducing hardware redundancy and lowering operational costs.

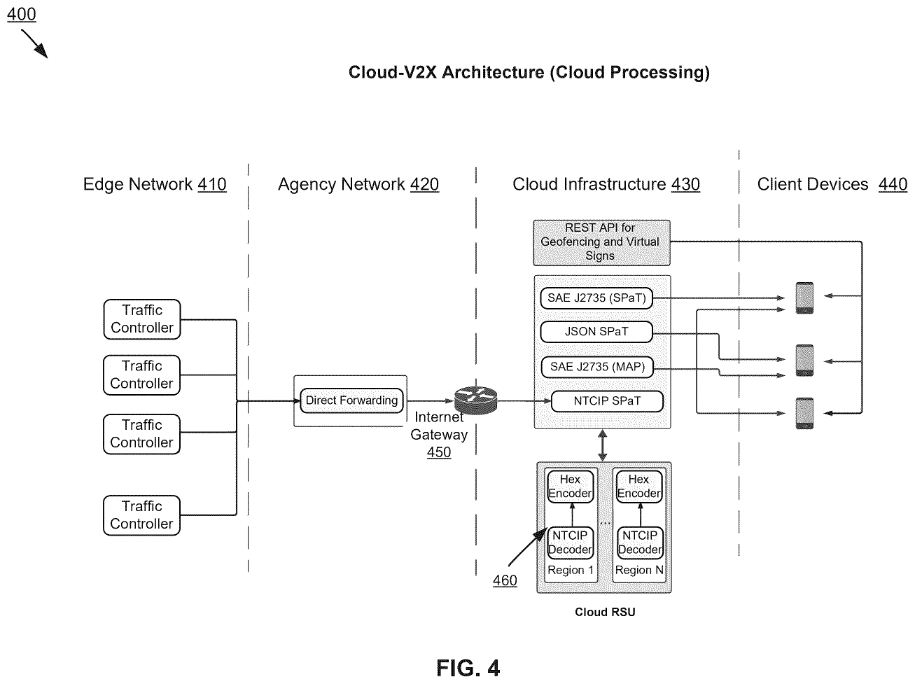

The agency server 108 serves as a dedicated hardware component within the architecture of system 100, which includes various functions, depending on the deployment configurations. In some embodiments, the agency server 108 is applicable in deployment configurations where local edge processing is not employed (e.g., cloud processing illustrated in FIG. 4). In such scenarios, the agency server 108 acts as the intermediary node to ensure continuous and reliable data acquisition and transmission. In some embodiments, the agency server 108 may be also responsible for SPaT data processing without necessarily relying on the cloud server processing (e.g., on-site processing illustrated in FIG. 5).

Depending on the specific architecture and deployment requirements of system 100, the agency server 108 may be configured as a lightweight computing resource, given that the heavy computational processing of SPaT data, such as encoding, formatting, and distribution, may be performed in the cloud layer (e.g., in the cloud processing illustrated in FIG. 4). The server's principal function then is to receive raw SPaT messages from one or more traffic signal controllers 102, perform minimal preprocessing or data handling operations, and forward the collected data to cloud-based services via an MQTT broker 122 REST API interface, or other software interfaces.

A notable advantage of the architecture shown in FIG. 1 is the multi-intersection handling capability of a single agency server 108. Unlike existing V2X systems that require a dedicated unit per intersection, the disclosed system 100 allows one server 108 to aggregate SPaT data from multiple intersections, particularly when connected through a shared fiber backbone network (which can be part of the network and communication infrastructure 106), thereby contributing to significant cost and infrastructure savings.

In some embodiments, the agency server 108 includes an embedded software module (e.g., SPaT data collection and forwarding module 124b) specifically designed to manage the data collection and forwarding process, ensuring efficient topic mapping, load balancing, and low-latency data delivery to the cloud-based processing layer. The inclusion of this server 108 in a given deployment scenario provides agencies with a flexible alternative to edge computing while maintaining real-time operational performance. In some embodiments, the agency server 108 may further include an SPaT data processing module 126b dedicated to SPaT processing, as will be described in detail later.

The cloud computing node 110 serves as a centralized processing and data distribution component within the disclosed cloud-based V2X system 100. In some embodiments, the cloud computing node 110 is employed across multiple deployment configurations, including cloud-only, edge-assisted, and on-site processing architectures. Regardless of the specific deployment model, the cloud computing node 110 plays a critical role in the delivery and management of SPaT data to the connected client devices 112.

In scenarios where SPaT data processing is offloaded from the edge (i.e., no edge device 104 is deployed) to the cloud computing node 110, the cloud computing node 110 performs both data processing and distribution functions. In alternative configurations, where local edge processing or on-premise processing occurs (e.g., through edge device 104 or agency server 108), the cloud computing node 110 remains responsible for publishing processed SPaT data to end-user devices 112 over a public or private network (which can also be part of the network and communication infrastructure 106), ensuring global accessibility and uniform data distribution.

One of the features of the cloud-based architecture is its elastic scalability. The cloud computing node 110 can be dynamically scaled based on real-time system demands. For instance, deployments encompassing a large number of traffic intersections in urban environments may utilize expanded cloud resources with multiple processing units, whereas smaller deployments, such as those in rural areas or low-traffic regions, can function efficiently with fewer allocated cloud resources.

In some embodiments, when there are multiple cloud computing nodes 110, a specific instance of cloud computing node 110 for relaying communication between the edge device 104 and the client device 112 may be automatically selected based on geographic or network proximity to the edge device 104. This selection is performed dynamically using a proximity-aware load balancing mechanism, which may include geolocation-based DNS resolution, latency measurement, or IP geofencing techniques. When the edge device 104 initiates communication, system 100 may evaluate the nearest cloud server instance, such as through integration with a content delivery network (CDN) or edge computing platform. By routing data through the closest cloud node 110, the system minimizes communication latency, optimizes data throughput, and enhances the real-time performance of SPaT data distribution. This dynamic instance selection ensures that communication pathways are both efficient and resilient, adapting automatically to changes in device location or network conditions.

In practical implementations, commercially available cloud service platforms such as Amazon AWS® EC2, Microsoft Azure®, or Google Cloud® may be utilized to provision virtual computing instances that dynamically handle SPaT data processing, encoding, and distribution. This configuration enables cost-efficient scaling, high availability, and geographically distributed service delivery, ensuring that client devices 112, whether located locally or remotely, can reliably access real-time SPaT data via Internet-connected platforms, including cellular and broadband networks.

It should be noted that, in addition to cloud-based implementations, the disclosed V2X system 100 also contemplates the use of an on-premise server option (e.g., agency server 108) to provide flexibility in deployment scenarios. In some embodiments, the delivery of processed SPaT data to client devices 112 is accomplished via the use of on-premise servers, thereby eliminating reliance on cloud infrastructure in data processing. This configuration is particularly advantageous for transportation agencies or municipalities that prefer data localization or that operate within environments where internet access is limited, controlled, or unavailable.

The on-premise server option enables direct communication with external clients 112, including vehicles, pedestrian devices, and other end-user systems, via TCP-based connections. Where agency network policies allow for incoming TCP connections, SPaT data can be processed and distributed locally (e.g., in the agency server 108), ensuring minimal latency and full control over data privacy and system security. This deployment flexibility ensures the adaptability of the V2X system 100 to meet diverse operational, regulatory, and technical requirements without sacrificing real-time performance.

An end-user device 112 refers to a client-side computing device configured to receive and display real-time SPaT data and other V2X messages transmitted by the disclosed system 100. These devices may include, but are not limited to, mobile phones, smartphones, tablet computers, laptops, desktop computers, vehicle-mounted infotainment systems, wearable devices, or other forms of computing hardware capable of establishing Internet or wireless network connections.

In some embodiments, end-user devices 112 connect to the cloud-based V2X system or on-premise servers via cellular networks (e.g., 4G, 5G), WiFi, Bluetooth, or satellite communication channels, ensuring widespread accessibility regardless of the user's location. These devices may execute a client-side software application (referred to as a client application 130) configured to subscribe to SPaT data streams, process incoming messages, and render traffic signal information on a graphical user interface (GUI) in real-time. In some embodiments, the client application 130 may be implemented as a native mobile application, such as an Android® application or iOS® application, or as a web-based application accessible via standard web browsers.

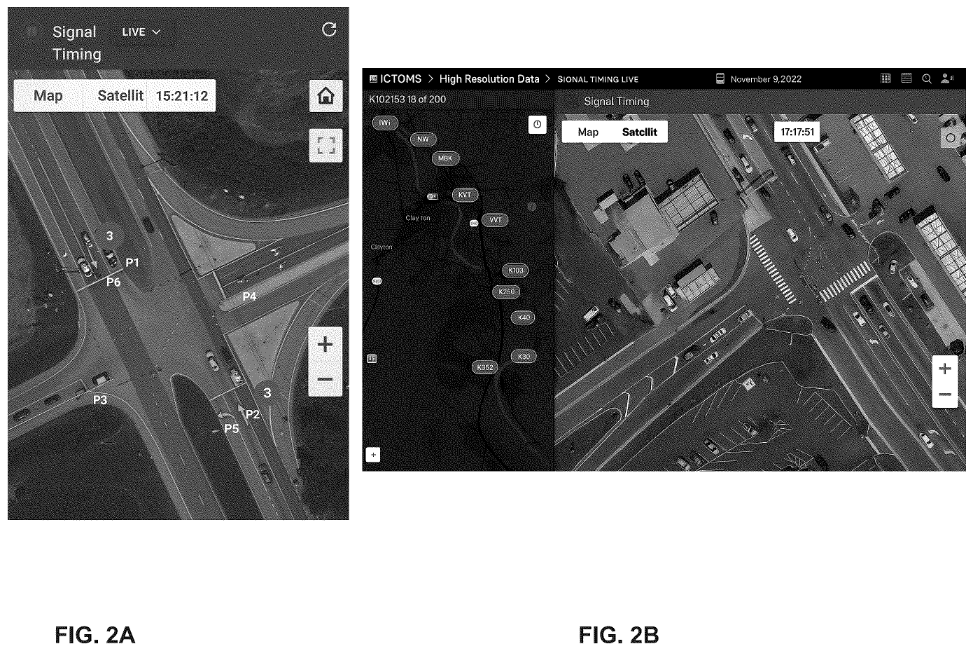

FIG. 2A illustrates an example of a smartphone user interface displaying live SPaT countdowns, where numeric indicators show the remaining time (in seconds) until phase transitions. FIG. 2B demonstrates a similar interface on a personal computer (PC), showcasing the adaptability of the client application 130 across various platforms.

Through the end-user devices 112, drivers, pedestrians, and other system participants gain real-time awareness of intersection signal status, enhancing road safety, driving efficiency, and overall user experience.

The specific software components of system 100 will be described in detail next.

An MQTT broker 122 disclosed herein is a messaging middleware application that facilitates real-time communication and data distribution between devices/clients using the MQTT protocol. MQTT is a lightweight, publish-subscribe messaging protocol specifically configured for efficient data transmission in bandwidth-constrained environments, making it suitable for Internet-of-things (IoT) and connected vehicle applications due to its efficiency and minimal bandwidth requirements.

In the disclosed system 100, the MQTT broker 122 serves multiple critical functions, including: (1) receiving messages published by various devices or software modules or applications, (2) filtering and categorizing messages based on topics, and (3) disseminating messages to subscribing client devices based on their topic subscriptions. Some key benefits and features of deploying an MQTT broker include its publish/subscribe model, quality of service (QoS), lightweight, high efficiency, and retained messages, among others.

In accordance with some embodiments, the MQTT broker 122 utilizes a publish/subscribe messaging architecture, enabling efficient and scalable data communication between SPaT data processing modules and end-user devices. Under this model, MQTT clients can publish messages to specific topics and subscribe to topics of interest to receive relevant data streams. For example, within the disclosed cloud-based V2X system 100, a plurality of docker containers may be instantiated, each responsible for processing SPaT data associated with a subset of traffic intersections. Each docker container operates a dedicated software module and establishes a persistent communication session with the MQTT broker 122 using a unique client identifier (client_id) to ensure isolated and traceable data flows.

In some embodiments, the communication between the docker containers and the MQTT broker may be implemented over an end-to-end TCP connection, e.g., through TCP port 1883, which is the standard port for MQTT communication, ensuring consistent and reliable message delivery across distributed system components. In some embodiments, the TCP connection with the MQTT broker uses a transport layer security (TLS) mechanism for encrypted communication. TLS provides confidentiality, integrity, and authentication by encrypting the data exchanged between the client (e.g., edge device 104 or cloud server 110) and the MQTT broker 122. This prevents eavesdropping, tampering, or spoofing by unauthorized entities during message transmission.

In some embodiments, the TCP connection established with the MQTT broker 122 is configured to disable Nagle's algorithm in order to support low-latency, real-time communication specifically optimized for SPaT data transfer. Nagle's algorithm, which is designed to improve network efficiency by aggregating small packets before sending them, is intentionally disabled in this context to eliminate the delays introduced by such buffering. By disabling the algorithm, e.g., through the TCP_NODELAY socket option, the system ensures that each SPaT message is transmitted immediately upon availability without waiting for the acknowledgement through standard TCP protocol This configuration is critical for time-sensitive vehicular and traffic signal applications, where even minimal transmission delays can impact safety or degrade system responsiveness. The low-latency communication achieved through this optimization supports precise and timely delivery of SPaT data from edge devices to clients via the MQTT messaging broker.

In some embodiments, each end device participating in the TCP-based communication with the MQTT broker 122, including but not limited to, an edge device 104, a server 108 within an agency-controlled network, and a smartphone client device 112, includes a dedicated local agent configured to implement the IEEE 1609.2 standard for secure vehicular communication. This local agent interacts with an SCMS API that is hosted locally on the device to manage the cryptographic operations necessary for authenticating V2X messages via digital signatures. Exemplarily, the local agent on an edge device 104 communicates with the SCMS API to authenticate each SPaT message received from a traffic signal controller 102, ensuring that the message is both cryptographically valid and originates from an authorized infrastructure source in compliance with IEEE 1609.2 standard. The local agent on the server 108 within the agency network likewise interacts with the SCMS API to validate digital signatures embedded in incoming V2X messages before relaying them to the MQTT broker 122, thereby preventing the propagation of unauthorized, spoofed, or tampered data and maintaining end-to-end trust. On the client side 112, the smartphone's local agent performs real-time digital signature validation on processed SPaT data received via the MQTT broker 122. It consults the locally hosted SCMS API to verify the authenticity and integrity of each message before rendering the information to the user, thereby upholding IEEE 1609.2 security requirements across all device endpoints within the communication system.

In some embodiments, the MQTT broker 122 employed in the disclosed cloud-based V2X system 100 supports multiple QoS levels, enabling customizable message delivery guarantee tailored to the requirements of different applications. Within the context of MQTT, QoS settings govern the reliability and frequency of message delivery between (i) the publishing client and the MQTT broker, and (ii) the MQTT broker and the subscribing client. These two delivery pathways operate independently, meaning the publishing client defines a QoS level during transmission to the broker, while each subscribing client independently specifies its preferred QoS level during subscription. In circumstances where there is a mismatch, the MQTT broker 122 may respect the lower QoS level between the publisher and subscriber to optimize performance.

Due to the strict low-latency requirements inherent in real-time V2X communication, system 100 may utilize a QoS level of 0, the “fire-and-forget” mode, for the publication and distribution of SPaT data. This approach minimizes transmission delays, avoids message overhead, and ensures the fastest possible end-to-end data delivery, which is critical for safety-related vehicular applications where real-time responsiveness is prioritized over guaranteed message delivery.

With respect to the features of lightweight and high efficiency, the MQTT protocol employed in the disclosed V2X system 100 is configured to be optimized for high efficiency, making it particularly well-suited for environments with limited computational resources and constrained network bandwidth. By utilizing a minimal protocol overhead and an efficient publish/subscribe architecture, MQTT ensures low data transmission costs and reduced processing demands on both client devices and server infrastructure. In some embodiments, the MQTT broker 122 can be deployed on resource-constrained devices, such as a Raspberry® Pi, to perform SPaT data processing and distribution at the edge of the network. This capability allows transportation agencies to establish cost-effective, decentralized V2X communication nodes without the need for high-performance servers, while still maintaining reliable and real-time data dissemination essential for connected vehicle applications.

In some embodiments, the MQTT broker 122 in the disclosed cloud-based V2X system 100 incorporates a message retention feature that allows the last published message on a given topic to be stored and automatically delivered to any newly connected subscribers of that topic. This functionality is especially advantageous for broadcasting MAP messages and other relatively static datasets, where the latest version of the data remains valid for extended periods. For instance, when a client device initiates a subscription to SPaT or MAP data, the most recent message is immediately delivered without requiring the system to query or regenerate the data, thereby reducing server workload, improving response time, and ensuring timely access to essential intersection and roadway information. This retained message capability contributes to system efficiency while maintaining real-time accessibility for end-user devices.

In some embodiments, the MQTT broker 122 within the disclosed cloud-based V2X system 100 is configured with deployment flexibility, allowing it to be hosted at various network layers, including the edge (near intersections), within an agency's local server environment, or in a cloud computing infrastructure, depending on the selected system architecture. In other words, the MQTT broker 112 does not require to be hosted on a mobile edge computing (MEC) platform owned by a cellular operator as existing V2X does, but can be hosted on a cloud server or other non-MEC infrastructure, allowing for flexible deployment and scalability without reliance on cellular operator infrastructure. In some embodiments, when the MQTT broker 122 (e.g., the MQTT broker 122c in FIG. 1) is deployed in the cloud, it serves as a virtual RSU, facilitating the distribution of SPaT data and related messages to end-user devices following the processing of raw data within the cloud environment. The broker architecture is inherently scalable, capable of handling tens of thousands or hundreds of thousands of simultaneous client connections and supporting high-throughput message exchanges. Moreover, in some embodiments, the system may incorporate multiple MQTT brokers, each responsible for separate publish/subscribe (pub/sub) operations, enabling load balancing, fault tolerance, and operational efficiency across large-scale V2X deployments.

In some embodiments, an end-user device 112 is configured to dynamically select the nearest available MQTT broker 122 based on its current geographic or network proximity. This proximity-aware selection process may utilize geolocation data from the client device, network latency measurements, or DNS-based region resolution to identify and connect to the MQTT broker instance that offers the lowest communication latency. By establishing a connection with the closest available broker, system 100 reduces transmission delays and enhances the responsiveness of SPaT data delivery to the client. This dynamic broker selection mechanism allows for optimized real-time data exchange across a distributed broker infrastructure, improving performance and user experience while maintaining consistent message integrity and delivery reliability.

Referring now to the SPaT data collection and forwarding module 124, which is a software component that is optionally deployable on an edge device 104 (not shown) or a server (e.g., the server 108) within the agency's local network. Its primary function is to receive raw SPaT data transmitted from multiple traffic signal controllers 102 and to publish the collected data to an MQTT broker 122 in its original or raw format, such as the traffic signal controller broadcast message (TSCBM) or NTCIP 1202 format, thereby maintaining data integrity during the transmission process.

In some embodiments, the SPaT data collection and forwarding module 124 listens for incoming UDP traffic on port #1034 and employs an internal hash map mechanism to associate incoming data packets with their respective traffic signal controllers, based on source IP address mapping with the <id> of the traffic signal controllers 102. This enables the system to determine which data comes from which traffic signal controller efficiently, which then allows to identify and process SPaT messages from thousands of controllers simultaneously. Once collected, the SPaT data collection and forwarding module 124 publishes the SPaT data to the MQTT broker 122, tagging each message by topics that correspond to the unique identifiers (IDs) of individual traffic signal controllers 102, thereby enabling topic-based filtering and selective data delivery.

In some embodiments, the SPaT data collection and forwarding module 124 may filter out non-essential data elements, such as vehicle or pedestrian detection signals, to ensure that only relevant SPaT information is delivered to end-user devices 112. For example, some traffic signal controllers may also receive data from sensors for car or pedestrian detection, which can be filtered and not presented to the end users when delivering the SPaT data. In some embodiments, due to its lightweight architecture, the total forwarding delay introduced by the SPaT data collection and forwarding module 124 is minimal, e.g., within the range of 15 to 30 milliseconds per controller. This high efficiency allows a single server with modest processing resources to handle and forward SPaT data from hundreds of traffic signal controllers 102 while maintaining real-time performance standards.

Referring now to the SPaT data processing module 126, which is a containerized software application responsible for the processing, formatting, and transformation of SPaT data within the disclosed cloud-based V2X system 100.

A primary function of the SPaT data processing module 126 is to clean and validate incoming SPaT data received from multiple traffic signal controllers 102. This includes verifying message integrity, filtering out incomplete or corrupted data packets, and eliminating redundant messages. By performing these validation steps, system 100 may ensure that only accurate and reliable data progresses through the communication pipeline, which is essential for maintaining system stability and low-latency performance.

In some embodiments, the SPaT data processing module 126 also executes data format transformation, e.g., converting the NTCIP 1202 standard message format, commonly used by traffic signal controllers, into JSON format for intermediate processing and compatibility with modem web-based services. Where required, system 100 may further transcode the data into SAE J2735 unaligned packed encoding rules (UPER) format, enabling interoperability with in-vehicle systems and industry-standard connected vehicle applications. This multi-level transformation allows the system to flexibly support both human-readable interfaces (e.g., smartphone apps using JSON) and machine-to-machine communications (e.g., in-vehicle devices using SAE J2735).

In some embodiments, in addition to format conversion, the SPaT data processing module 126 may organize processed data into structured MQTT topics, such as per-intersection topics or geohash-based topics, facilitating targeted and efficient dissemination to subscribed client devices. For example, SPaT data from a particular intersection may be published under a topic like v2x/spat/intersection/102, ensuring that end-user devices receive only the specific data relevant to their location.

In some embodiments, the SPaT data processing module 126 further incorporates latency optimization features, including timestamp synchronization and countdown accuracy adjustments, which account for network transit delays and clock drift between traffic signal controllers and cloud servers. This ensures the phase countdown values displayed on client devices accurately reflect real-time signal behavior at each intersection.

In some embodiments, the SPaT data processing module 126 may also support data aggregation and sensor data management by filtering auxiliary information, such as vehicle or pedestrian detection signals as described above. This capability allows agencies to streamline the broadcast of essential SPaT data while optionally enabling more comprehensive data delivery when needed. Collectively, these processing functions enable system 100 to deliver high-quality, low-latency SPaT information to a broad range of client devices 112 and applications 130.

In some embodiments, the SPaT data processing module 126 may further digitally sign and verify the processed SPaT data by applying cryptographic techniques. In one example, a third-party SCMS API leveraging the IEEE 1609.2 protocol may be utilized for such purposes. Through this process, it can ensure data authenticity, integrity, and trustworthiness of SPaT messages before they are distributed in the V2X communication environment.

Specifically, before the processed SPaT data can be broadcast, system 100 may obtain a short-term pseudonym certificate from the SCMS. This involves securely interfacing with the SCMS API to authenticate the device and receive a temporary digital identity and corresponding private key, both of which comply with the IEEE 1609.2 security standard. Using the private key, the system digitally signs the processed SPaT data, producing a message that includes the original payload, the digital signature, and the pseudonym certificate. This signed message is then broadcast to surrounding vehicles and devices. Upon receipt, the vehicle (e.g., the local agent described earlier) extracts the certificate and uses the associated public key to verify the digital signature. The vehicle also checks the certificate's validity (e.g., expiration or revocation status) through mechanisms like certificate revocation lists (CRLs) or online certificate status protocol (OCSP) lookups provided by the SCMS. If the signature is valid and the certificate is trusted, the receiving system treats the SPaT data as authentic and untampered. This cryptographically secured process ensures that only legitimate infrastructure sources are able to distribute trusted traffic signal data in real-time, which is critical for safety and decision-making in the intelligent transportation system (ITS).

In some embodiments, the SPaT data processing module 126 may leverage containerization technology, whereby the application code, required operating system libraries, and dependencies are packaged together into a lightweight, self-sufficient executable container. This containerized architecture ensures consistent performance and functionality across various infrastructure environments, including cloud servers, edge devices, or on-premise systems.

According to some embodiments, the container-based deployment provides substantial flexibility and scalability. For instance, the SPaT data processing capacity can be dynamically scaled by adjusting the number of active docker containers within the processing server or cloud environment, enabling the system to accommodate varying numbers of traffic intersections based on deployment size or real-time traffic demands. This architecture facilitates efficient resource utilization, cost-effective scalability, and ease of maintenance, making the system adaptable to both small-scale municipal deployments and large-scale metropolitan implementations.

In some embodiments, the SPaT data processing module 126 incorporates a configuration file that defines operational parameters for each docker container, including the assignment of specific traffic signal controllers to each processing instance. This configuration file enables flexible, scalable, and modular deployment, allowing system 100 to dynamically allocate resources based on deployment size and system load. To further enhance processing efficiency and scalability, system 100 may employ a resource allocation algorithm, implemented as a grouping or clustering algorithm, that automatically distributes the total number of intersections among the available docker containers. The algorithm is configured to optimize processing delays by considering the raw data arrival patterns from the traffic signal controllers.

In some embodiments, one of the main features of the clustering algorithm involves sorting intersections based on their internal clock timestamps to account for the sequence in which SPaT data is received. The algorithm may then apply a round-robin grouping strategy, assigning intersections to docker containers in a way that balances the load while introducing sufficient intervals between SPaT message arrival times within each container. This approach helps to reduce peak processing loads, minimize queue congestion, and ensure consistent low-latency performance across all processing units, even in large-scale deployments involving hundreds or thousands of intersections. The disclosed algorithm provides a self-optimizing and highly scalable processing architecture, adaptable to variable traffic volumes and heterogeneous network environments.

Here the following is an exemplary pseudo-code for traffic signal controller assignment:

# Define the number of targeted containers and the id of the controllers
n_containers = ...
list_of_controllers=[controller_ids]
# Step 1: Subscribe to a set of TSCBM/NTCIP message from MQTT
[(arrival_timestamps, controller_id)] = subscribe_to_mqtt(list_of_controllers)
# Step 2: Sort the arrival sequence of controllers
sorted_controller_sequence = sort_by_timestamp([(arrival_timestamps,
controller_id)])
# Step 3: Assign controllers to bins using round-robin scheduling
bins = assign_controllers_to_containers(sorted_controller_sequence, n_containers)

In some embodiments, the SPaT data processing module 126 is configured to output SPaT data in multiple formats, thereby supporting a wide range of client application requirements and interoperability standards. The processed SPaT data is published to the MQTT broker 122 under separate, clearly defined topics, each corresponding to a specific data format. For example, in one embodiment, the SPaT data is made available in three primary formats: (1) the raw SPaT data in TSCBM or NTCIP 1202 format, which preserves the original broadcast structure from the traffic signal controllers; (2) a JSON (JavaScript Object Notation) formatted version, suitable for web-based applications and human-readable interfaces; and (3) an SAE J2735 format encoded using UPER in hexadecimal form, which is compatible with in-vehicle systems and connected vehicle applications requiring standardized binary encoding.

This multi-format broadcasting strategy enables flexibility for developers, integrators, and end-users, ensuring compatibility with diverse client platforms ranging from mobile applications to automotive onboard units (OBUs). It should be noted that system 100 is not limited to these three formats, and the SPaT data processing module 126 may be further configured to support additional formats as required by future standards or customer-specific use cases.

Referring now to the REST API 128, which serves as a cloud-based software interface within the disclosed V2X system 100, providing location-aware access to SPaT data, intersection information, and virtual sign functionalities. The REST API 128 is configured to enable client applications, such as mobile devices or in-vehicle systems, to efficiently retrieve SPaT information for nearby intersections, along with associated intersection identifiers and their corresponding geographic coordinates (latitude and longitude). In some embodiments, the REST API 128 utilizes geohash-based geofencing techniques to determine the real-time location of client devices and to dynamically filter and return a list of intersections located within a defined geospatial proximity.

In some embodiments, system 100 employs geohashing, a widely used geocoding method that converts geographic coordinates into short alphanumeric strings, with each string representing a grid cell of defined resolution on the map. The length of the geohash string controls the precision of location encoding, where longer strings correspond to smaller, more precise cells. For example, in some embodiments, the REST API 128 identifies intersections residing within eight neighboring geohash cells (or a configurable number of cells) relative to the client's current geohash location and returns the relevant intersection list.

In some embodiments, in addition to SPaT data retrieval, the REST API 128 also facilitates access to traveler information messages (TIM) and virtual sign services, including real-time countdown timers and dynamic traffic alerts, as illustrated in FIG. 2A. This geofencing-enabled REST API 128 empowers client devices to receive location-specific V2X information, optimizing data relevance while minimizing network bandwidth usage and ensuring real-time situational awareness for road users.

Referring now to the client application 130, which is a software application configured to operate on various end-user devices 112, including but not limited to mobile phones, tablets, vehicle infotainment systems, and other connected devices. The primary function of the client application 130 is to receive and display SPaT and MAP data in real time, enhancing situational awareness for drivers and pedestrians. The client application 130 establishes a persistent connection to the cloud-based MQTT broker 122, for example, by using a unique client identifier (client_id) to subscribe to SPaT topics corresponding to the nearest traffic intersection.

In some embodiments, the client application 130 integrates with the REST API server to perform geofencing queries, whereby the application retrieves a list of nearby intersections along with their geographic coordinates. The client application 130 calculates the distance to each intersection in the list and dynamically identifies the nearest intersection relative to the client's real-time location and trajectory. Based on this determination, the client application 130 subscribes to the relevant SPaT and/or MAP data topics limited to that specific intersection, ensuring that users receive localized and up-to-date traffic signal information.

As the client device 112 moves, the application 130 continuously monitors positional changes and automatically switches subscriptions when transitioning from one intersection's service area to another. For example, during a vehicle's trajectory, the client application 130 may unsubscribe from the previous intersection's SPaT topic and subscribe to a new intersection as the vehicle approaches the next relevant signalized intersection. In scenarios where the vehicle travels on highways or areas without nearby intersections, the client application 130 may suspend SPaT subscriptions, thereby conserving network resources and eliminating unnecessary data retrieval.

It should also be noted that, while various traffic signal controllers, edge devices, client devices, servers, and cloud computing node are illustrated in the cloud-based V2X system 100 in FIG. 1, it will be appreciated that more or fewer components may be used instead, depending on different deployment options. In addition, the specific software components included in each hardware component may also vary, depending on the specific deployment options.

### Overall Method

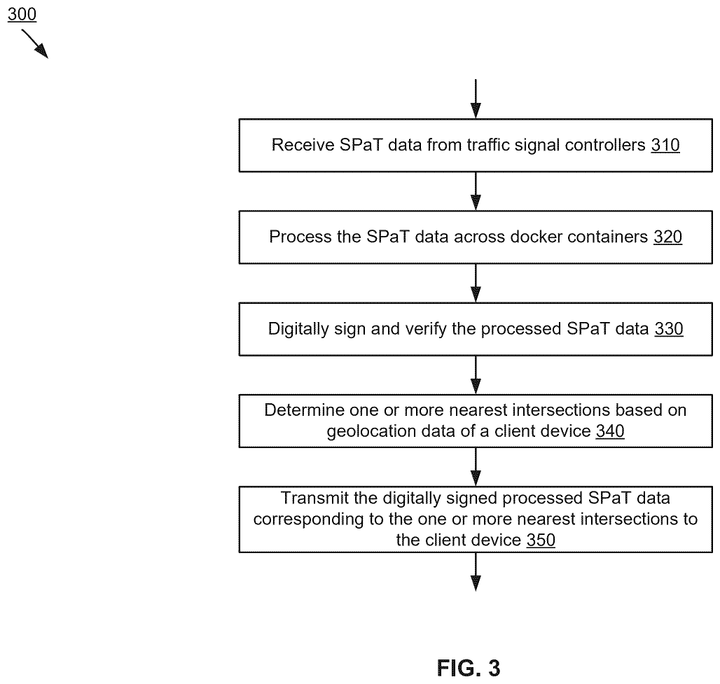

Referring now to FIG. 3, an example process flow 300 for providing real-time broadcast of SPaT data by using cloud-based V2X is provided, according to some embodiments.

At step 310, the process flow 330 begins by receiving SPaT data from one or more traffic signal controllers located at signalized intersections. The incoming data may be formatted in either the NTCIP 1202 standard or in the SAE J2735 format. These formats provide structured representations of traffic signal status, such as signal phases, remaining time until changes, and pedestrian intervals. The system is configured to accept and handle both data formats to ensure compatibility with a wide range of intersection control systems.

At step 320, upon reception, the SPaT data is processed using a distributed computing architecture that leverages docker containers. For example, the NTCIP 1202 data is first converted into one or more formats suitable for further analysis and communication. The processing tasks are intelligently distributed across multiple containers based on a grouping or clustering algorithm. This algorithm dynamically allocates the processing load by considering the raw data arrival sequence from various traffic signal controllers, thereby optimizing system performance and ensuring real-time responsiveness.

At step 330, prior to distribution, the processed SPaT data is digitally signed and verified using a third-party SCMS API in compliance with the IEEE 1609.2 protocol. The digital signature ensures data authenticity and integrity by allowing receiving entities to verify that the data has not been tampered with and originates from a trusted source. The SCMS provides the necessary digital certificates and cryptographic keys for signing. The signed data packet includes the signature, certificate, and payload, enabling end-to-end verification across vehicular communication networks.

At step 340, the system further determines the nearest intersections relevant to a mobile client device (e.g., a moving vehicle or a mobile phone) by utilizing geolocation data received from the device. This is accomplished through a cloud-hosted RESTful API that maps the client's coordinates to one or more proximate intersections. The API maintains a geospatial index of known signalized intersections and uses spatial query algorithms to efficiently identify intersections within a defined proximity radius or road network topology of the mobile client device.

At step 350, the processed and verified SPaT data corresponding to the identified nearest intersections is transmitted to the mobile client device. The data is sent in an SAE-defined format suitable for in-vehicle systems or mobile applications, ensuring interoperability and compliance with existing ITS and V2X communication standards. The data may be also sent in other different forms, as described earlier. This step completes the secure and real-time delivery of traffic signal information to end users, facilitating safer and more efficient transportation decisions.

In some embodiments, to facilitate asynchronous and scalable data exchange, the system utilizes a cloud-hosted publish-subscribe based messaging broker, such as an MQTT broker. This broker enables decoupled communication between data producers (e.g., SPaT data processors) and data consumers (e.g., downstream services or client-facing APIs). Each component in the system subscribes to or publishes messages via specific topics, ensuring reliable delivery of processed SPaT data to interested entities without the need for direct polling or constant request handling.

In some embodiments, the system is designed to communicate over heterogeneous network links via the Internet, utilizing any combination of available network interfaces such as Ethernet, fiber-optic connections, 5G or LTE cellular networks, and satellite links. This multi-modal communication capability ensures robust, flexible, and redundant connectivity across diverse environments, including urban, rural, and remote areas. Unlike conventional vehicular communication systems that rely on direct V2X transmissions over the 5.9 GHz DSRC band, this system operates independently of such requirements. It eliminates the dependency on 5.9 GHz-based radio infrastructure by leveraging standard IP-based communication channels and commercial-grade networking infrastructure. As a result, the system provides a scalable, deployment-agnostic platform for delivering real-time traffic signal data and related messages without necessitating dedicated V2X hardware or spectrum allocation.

### Specific Implementations

In the following, three different deployment options for the above-described hardware and/or software components are further described. These different deployment options have different costs and resource requirements, allowing to serve different customer needs.

FIG. 4 is a block diagram of an example cloud-based V2X system 400, representing a cloud processing deployment configuration in accordance with embodiments of the disclosure. In this cloud-centric architecture, the SPaT data generated by traffic signal controllers is processed entirely within a cloud environment 430, minimizing on-premise processing requirements and enabling centralized, scalable data management. As illustrated in FIG. 4, the cloud-based V2X system 400 includes four primary network layers: an edge network 410, an agency network 420, a cloud infrastructure 430, and a collection of client devices 440.

In the illustrated embodiment, the edge network 410 includes a set of traffic signal controllers deployed at or proximate to traffic intersections, which are configured to generate SPaT data during normal operation. Notably, in this cloud processing configuration, there is no edge device present within the edge network 410. All SPaT data processing occurs in the cloud 430. Upon generation, the SPaT data is directly forwarded from the traffic signal controllers to the cloud 430 via the agency network 420, which serves as a communication relay. This architecture eliminates the need for on-site processing hardware, reducing infrastructure costs while maintaining centralized, scalable, and low-latency processing capabilities within the cloud environment.

The agency network 420 may incorporate an agency server, which is responsible for aggregating SPaT data from traffic signal controllers and forwarding it to the cloud 430. In this configuration, the agency server may operate as a lightweight computing resource, given that the primary data processing, formatting, and distribution tasks are executed within the cloud environment. To facilitate seamless communication between the agency network 420 and the cloud infrastructure 430, an internet gateway 450 is included, establishing a network bridge between local networks and cloud services. The internet gateway 450 functions as a network node that connects heterogeneous networks utilizing different communication protocols. In certain implementations, the internet gateway 450 may be implemented as a router alone, particularly when a modem is integrated within a traffic cabinet, or as a combination of a modem and router when a standalone modem is required. Once the SPaT data is transmitted through the internet gateway 450, it is subsequently received and processed within the cloud 430, enabling centralized, real-time traffic data processing and broadcast to end-user devices.

Within the cloud infrastructure 430, the system provisions flexible and dynamically scalable computing resources, including virtual CPUs, memory, and storage capacity, which are allocated in proportion to the number of traffic signals and overall data throughput requirements of the V2X system. Public cloud service providers, such as Microsoft Azure®, Amazon Web Services (AWS EC2®), and Google Cloud®, offer the ability to elastically scale computing resources, allowing the system to seamlessly increase or decrease processing capacity in response to real-time traffic demands, peak operational hours, or deployment expansions. This architecture ensures cost-efficient resource utilization while maintaining high reliability and minimal latency for real-time applications.

Within this cloud-based environment, the system deploys one or more MQTT brokers, each capable of handling high-throughput message brokering for both internal data routing and external publication to thousands of subscribing client devices 440. These MQTT brokers may be configured to publish SPaT data in multiple formats simultaneously, thereby supporting heterogeneous client devices with varying data format requirements. For example, a first client device may receive SAE J2735-compliant SPaT and MAP messages encoded in UPER HEX format, suitable for in-vehicle systems; a second client device may subscribe to SPaT data in JSON format combined with MAP data in J2735 format for use in mobile or web applications; and a third client device may receive only MAP data without accompanying SPaT information, depending on application needs. It is noted that different combinations and permutations of possible formats handled by the MQTT brokers are within the spirit and the scope of the disclosure.

In some embodiments, the cloud-based V2X system 400 is further configured to support SPaT data distribution in NTCIP 1202 raw format, enabling backward compatibility with legacy systems and client applications. Specifically, a fourth client device may subscribe to an MQTT topic corresponding to NTCIP-formatted SPaT data, receiving the unmodified or minimally processed raw SPaT messages directly from the cloud MQTT broker. This configuration is beneficial for agency-operated monitoring systems, traffic management centers, or specialized client devices that rely on NTCIP 1202 SPaT messages for internal processing or integration with existing traffic control infrastructure. By offering multi-format dissemination, including SAE J2735, JSON, and NTCIP 1202 formats, the system ensures interoperability with both modern connected vehicle applications and traditional traffic management systems.

In some embodiments, the cloud layer 430 includes a REST API server responsible for generating virtual sign messages, advisory speed limits, or warning notifications, which may be graphically rendered as overlays on navigation maps within client applications. The REST API incorporates geofencing capabilities, which utilize geohashing algorithms to determine a client's geographic location and deliver location-specific SPaT and MAP data, prioritizing information from the nearest or most relevant intersections. This combination of multi-format data delivery, dynamic resource scaling, and geofencing-based personalization ensures the system can effectively serve large-scale deployments while maintaining low latency and operational efficiency for safety-critical transportation applications.

In some embodiments, the cloud layer further includes a plurality of docker containers 460, each configured to perform dedicated SPaT data processing functions. Each docker container 460 is equipped with an NTCIP decoder module, which is responsible for decoding raw SPaT messages transmitted in NTCIP 1202 format from traffic signal controllers from one region (e.g., Region 1/Region N in FIG. 4). Following decoding, the docker containers 460 may execute data transformation processes, including format conversion and encoding. For applications or client devices requiring binary message encoding, each docker container further comprises a HEX encoder module, which converts the processed SPaT data into SAE J2735 format or other compressed hexadecimal formats. This modular design allows for efficient, scalable, and flexible cloud-based SPaT data processing, ensuring interoperability with a variety of downstream client devices, including both modern connected vehicle systems and legacy transportation infrastructure.

It should be noted that, for the docker containers in the cloud RSU, the exact number may vary and may not correspond to the number of intersections for data processing. For example, one docker container may process signals from multiple interactions.

Referring now to FIG. 5, a block diagram of another example of a cloud-based V2X system 500 is presented, illustrating an embodiment configured for edge processing. In the illustrated embodiment, the SPaT data generated by traffic signal controllers is processed locally in the edge network 510, e.g., on an edge device, which is deployed near the intersection or within the agency's local network infrastructure. This deployment model is referred to as edge processing, as the critical data decoding, transformation, and formatting tasks are executed directly on the edge device. This architecture offers the advantage of ultra-low latency performance, reducing network transmission delays and supporting real-time V2X data dissemination to client devices, particularly in scenarios where rapid local responsiveness is a priority.

As shown in FIG. 5, the cloud-based V2X system 500 for edge processing includes an edge network 510, a cloud infrastructure 530, and multiple client devices 540. The edge network 510 and cloud infrastructure 530 are configured differently from the edge network 410 and cloud infrastructure 430 described in the cloud processing configuration of FIG. 4. Specifically, in this edge processing model, the data collection and forwarding functions are performed directly within an edge device, eliminating the need for an intermediate agency server. Unlike the cloud processing architecture, where SPaT data passes through an agency network, the edge processing system 500 achieves full local processing of SPaT data at the edge device, which handles data collection, resource allocation, SPaT data decoding and formatting, and forwarding of processed data.

The edge processing configuration offers significant deployment simplicity and reduces infrastructure costs, as the agency network 510 does not require dedicated servers for SPaT data processing. Additionally, the edge device forwards processed SPaT data to the cloud infrastructure 530, where it can be further distributed to client devices 540. The data transmission from the edge to the cloud may utilize either a backbone fiber network or a cellular network, with the connection established via an internet gateway. This hybrid connectivity approach ensures flexibility in network infrastructure while maintaining real-time broadcast capabilities for connected vehicle applications.

In some embodiments, the docker container-based application deployed on the edge device enables the processing of SPaT data from multiple intersections using a single edge device. This approach differs from conventional V2X systems, which typically require a dedicated edge device installed at each individual intersection, resulting in higher deployment costs and operational complexity. By aggregating and processing SPaT data from multiple intersections through dockerized containers on a single edge device, the disclosed system offers a more cost-effective and manageable infrastructure solution. However, it should be noted that due to the limited computational resources available on standard edge devices, this edge processing architecture may present scalability limitations, particularly in large-scale urban deployments where a high volume of intersections and high-frequency data streams may exceed the processing capacity of localized edge hardware.

In some embodiments, once the processed SPaT data is transferred to the cloud infrastructure 530 from the edge device, various client devices 540 may subscribe to and receive SPaT messages published by the cloud infrastructure 530. The cloud infrastructure supports multi-format data dissemination, allowing different client devices to subscribe to specific SPaT data formats according to their application requirements and technical capabilities. For example, certain client devices may subscribe to SAE J2735 UPER-encoded SPaT data suitable for vehicle onboard units, while others may subscribe to JSON-formatted SPaT data optimized for mobile applications or web-based platforms. This flexible publish-subscribe model enables the efficient distribution of location-specific traffic signal information, promoting interoperability across diverse device ecosystems and supporting a wide range of connected transportation applications.

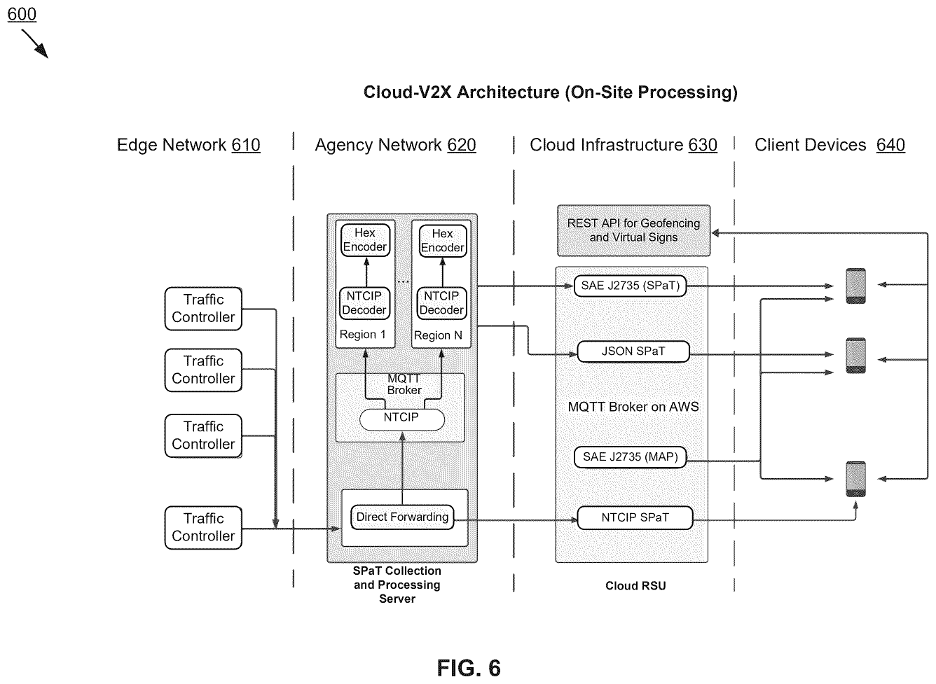

Referring now to FIG. 6, a block diagram of an alternative embodiment of a cloud-based V2X system 600 is provided, illustrating a deployment configuration referred to as on-site processing. In this embodiment, the SPaT data generated by traffic signal controllers is processed within an agency network 620, rather than within edge devices or the centralized cloud infrastructure 630. The agency network 620 may include SPaT collection and processing server, which may specifically refer to individual SPaT data collection and forwarding server, SPaT data processing server, or a combination thereof. This on-site data processing approach enables the system to achieve a balanced architecture by processing data locally at agency-managed facilities, thereby reducing end-to-end latency while maintaining greater scalability compared to traditional edge-only deployments. By centralizing SPaT data processing within the agency network 620, the system can accommodate a larger number of intersections without the need to deploy individual edge devices at each intersection, while still providing real-time data responsiveness suitable for connected vehicle applications.

As shown in FIG. 6, the cloud-based V2X system 600 includes four primary components: an edge network 610, an agency network 620, a cloud infrastructure 630, and a plurality of client devices 640. In this embodiment, the edge network 610 is functionally similar to the edge network 410 depicted in FIG. 4, incorporating traffic signal controllers and communication hardware, but without localized SPaT processing at the intersection level. The agency network 620 differs from the agency network 420 in FIG. 4, as in the system 600, SPaT data processing is actively performed within the agency network 620, rather than being limited to data forwarding as in system 400. The cloud infrastructure 630 operates similarly to the cloud infrastructure 530 shown in FIG. 5, primarily serving as a distribution platform for processed SPaT data, without engaging in SPaT decoding or transformation operations. The cloud infrastructure 630 focuses on publishing SPaT data in multiple formats, such as SAE J2735 UPER, JSON, and NTCIP formats, making the data accessible to various client devices 640, while relying on on-site processing within the agency network 620 for upstream data handling.

It should also be noted that the disclosed technology is not limited to the three specific deployment options described herein, namely, cloud processing, edge processing, and on-site agency network processing. Rather, the system architecture is designed to be flexible and adaptable, allowing for the implementation of alternative deployment configurations or hybrid models based on specific operational requirements, network infrastructure availability, and scalability goals. Additional deployment options may involve combinations of cloud, edge, and on-premise processing, or dynamic shifting between processing modes depending on traffic conditions, resource availability, or policy requirements, without departing from the scope of the present disclosure.

### Performance Evaluation and Field Test

A validation test was conducted at a field intersection in Smyrna (US 13 @DE 300) based on the on-site processing deployment option. The results from the field testing confirmed that the phase status displayed on the client-side smartphone application was accurately synchronized with the actual field traffic signal conditions, with phase transitions reflected in real time without any noticeable visual delay. Further detailed analysis, utilizing frame-by-frame video recording comparisons, indicated that the total end-to-end latency from the traffic signal controller to the smartphone display was approximately 40 to 50 milliseconds. This measured delay encompassed not only the communication latency through the traffic signal controller, SPaT collection and processing infrastructure, and wireless network transmission, but also accounted for the graphical rendering delay within the smartphone application interface. The observed latency demonstrated compliance with real-time performance requirements for connected vehicle applications and confirmed the effectiveness of the disclosed V2X system in field environments.

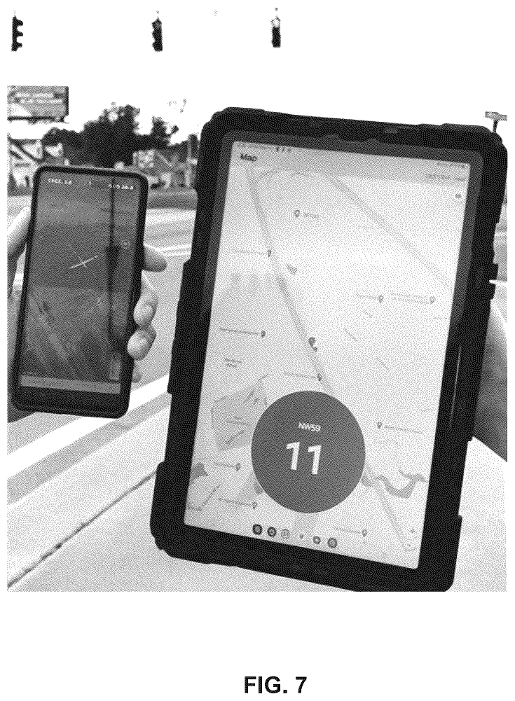

FIG. 7 illustrates example user interfaces captured from both a smartphone and a tablet device, where each interface displays virtual signs, including countdown timers that accurately reflect real-time phase transitions from the field intersection testing environment. The visual countdown indicator shown on the tablet corresponds directly to the actual traffic signal phases, providing road users with timely and reliable SPaT information. In addition to user interface validation, latency performance tests were conducted utilizing multiple cloud-based MQTT servers to assess the end-to-end system latency under realistic deployment scenarios. The results of these latency tests confirmed the system's ability to consistently achieve an average latency below 100 milliseconds, satisfying the stringent latency requirements for safety-critical V2X applications and aligning with industry safety performance standards established by various transportation authorities and regulatory agencies. These test outcomes further demonstrate the practical effectiveness and readiness of the disclosed cloud-based V2X system for field deployment.

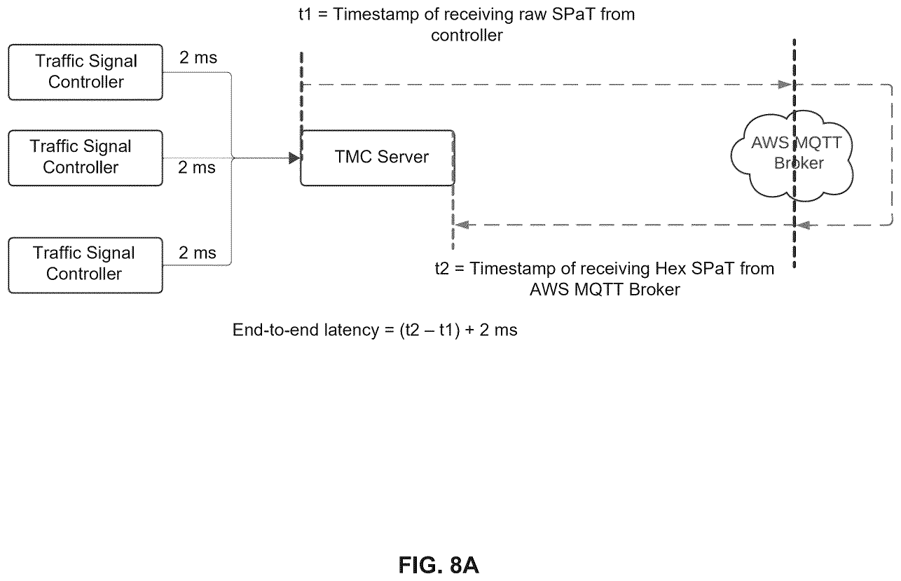

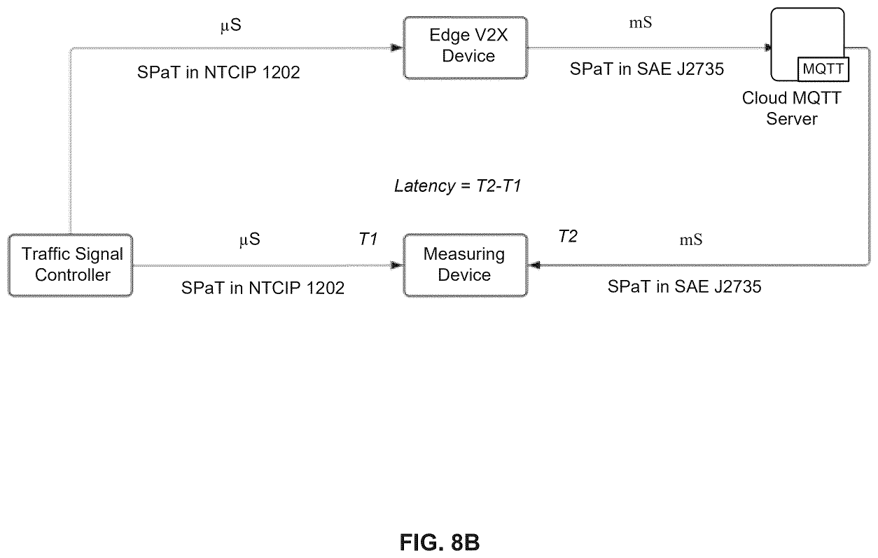

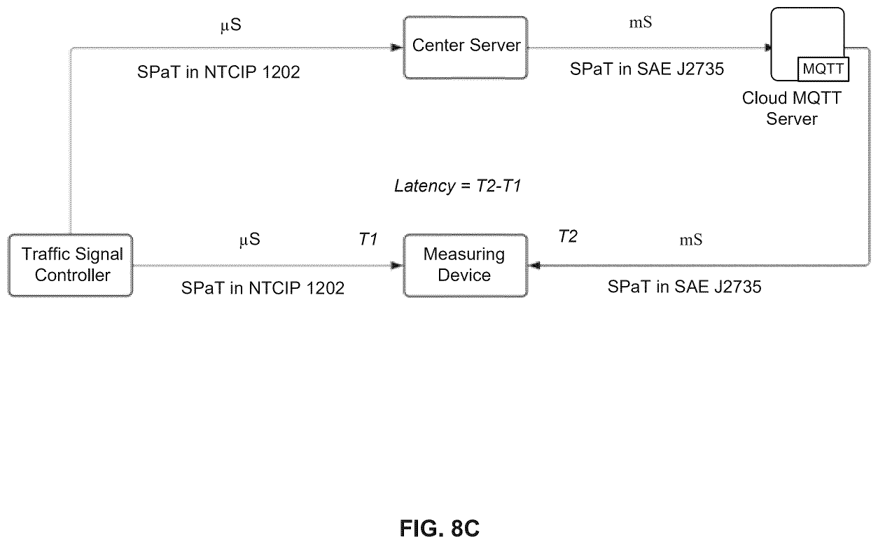

FIG. 8A illustrates a schematic representation of the end-to-end latency determination methodology for the disclosed cloud-based V2X system, in accordance with an embodiment. The end-to-end latency is defined as the cumulative delay experienced by SPaT data from its generation at the traffic signal controller to its presentation on a client device, and encompasses four components: (1) transmission delay, (2) queuing delay, (3) processing delay, and (4) propagation delay. A distinct advantage of the disclosed V2X system lies in its significantly reduced propagation delay, contributing to a lower overall end-to-end latency compared to conventional V2X architectures. In one test (specific numerical data not shown), the average propagation delay was measured at approximately 5 milliseconds, which is notably lower than the propagation delays typically observed in legacy V2X systems. This reduction in propagation delay, combined with optimized processing pipelines and efficient message distribution mechanisms, enables the system to achieve high responsiveness suitable for safety-critical V2X applications. FIGS. 8B and 8C illustrate two other different embodiments for end-to-end latency determination, where reflect different setups according to different configurations of the disclosed V2X systems. They provide the most accurate end-to-end latency measurements within the margin of error less then 0.1 ms when using 100 Mbps Ethernet and less than 0.01 ms for Gbps Ethernet between the traffic controller and measuring device.

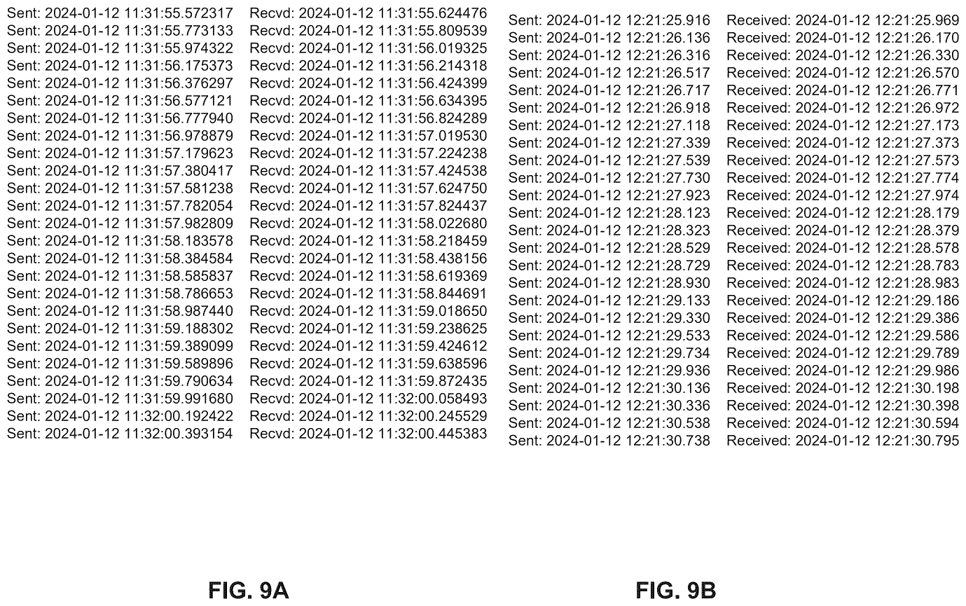

FIGS. 9A and 9B present latency test results derived from screenshots captured on two different smartphones operating in two separate U.S. states. Both tests utilized the same cloud MQTT server, hosted within an AWS data center located in Northern Virginia. The geographical distance between the client device locations and the cloud server played a significant role in latency performance, since propagation delay is directly influenced by physical distance. The test results demonstrate a clear trend where latency improves when the client device is geographically closer to the cloud server, as evidenced by comparative analysis between FIGS. 9A and 9B.

Across both test scenarios, the system consistently achieved an average end-to-end latency of approximately 50 milliseconds, despite differing network types (e.g., 4G with shorter distance and 5G with longer distance). These outcomes validate the robustness and efficiency of the disclosed cloud-based V2X system, confirming its ability to maintain low-latency performance across diverse network environments and geographic locations. Overall, these latency figures are well within the performance thresholds for safety-critical V2X applications, meeting or exceeding the standards specified by organizations such as the 5G automotive association (5GAA) and other industry regulatory agencies.

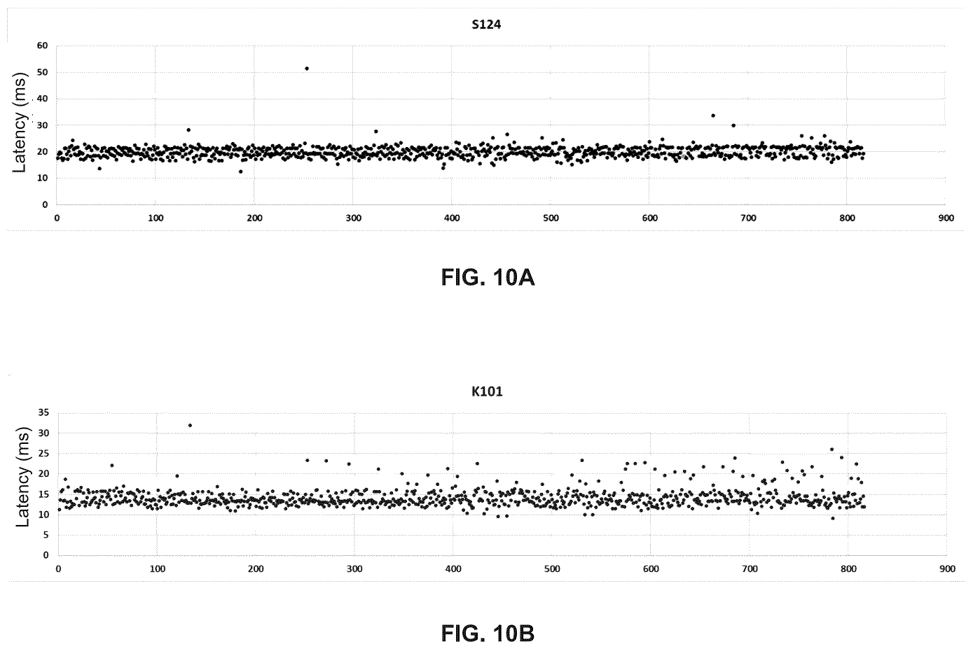

FIGS. 10A and 10B illustrate latency test results obtained from two different intersections within the same state of Delaware, validating the low-latency performance of the disclosed cloud-based V2X system under real-world deployment conditions. Specifically, FIG. 10A shows results from the southernmost traffic signal controller (S124), located near the Maryland border close to Ocean City. In this test, the system achieved an average end-to-end latency of 19.9 milliseconds, with the 99^{th} percentile latency remaining below 26 milliseconds, as indicated by the latency distribution plot. FIG. 10B presents latency test data from a different intersection (controller K101) at a separate location within Delaware, where the average latency was measured at 14.2 milliseconds, and the 99^{th} percentile latency stayed below 23 milliseconds.

These results demonstrate consistent, ultra-low-latency performance across diverse intersection environments within the same regional network, underscoring the efficiency, scalability, and real-time capabilities of the disclosed system. The measured latencies are well within the stringent performance thresholds required for connected vehicle safety applications, further confirming the system's suitability for nationwide V2X deployments in alignment with emerging transportation safety standards.

System and/or Computer Embodiments

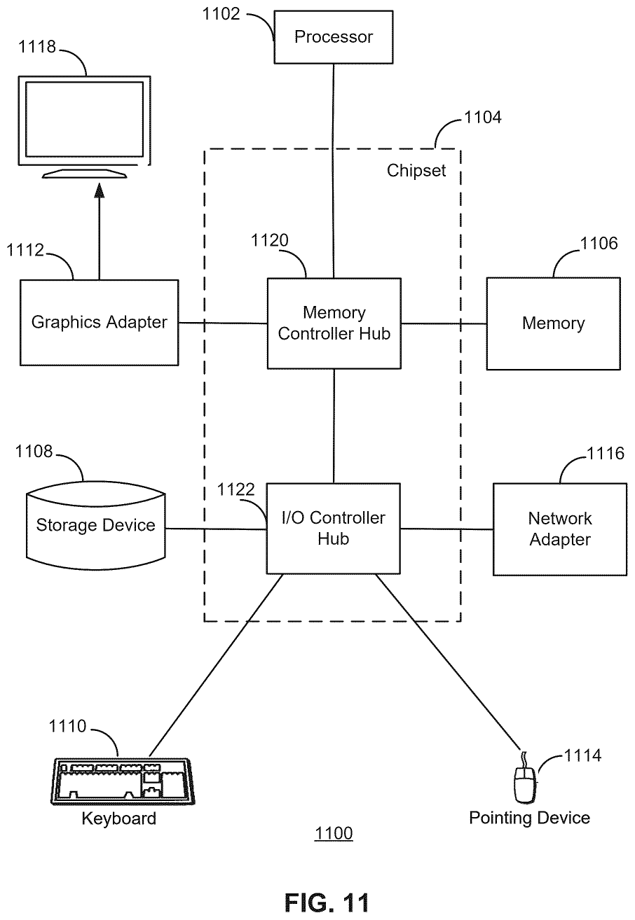

FIG. 11 depicts an example computing device 1100 for implementing systems and methods described in reference to FIGS. 2-5. Examples of a computing device may include a personal computer, desktop computer, laptop, server computer, a computing node within a cluster, message processors, hand-held devices, multi-processor systems, microprocessor-based or programmable consumer electronics, network PCs, minicomputers, mainframe computers, mobile telephones, PDAs, tablets, pagers, routers, switches, edge devices, IoT devices, and the like.

In some embodiments, the computing device 1100 includes at least one processor 1102 coupled to a chipset 1104. The chipset 1104 includes a memory controller hub 1120 and an input/output (I/O) controller hub 1122. A memory 1106 and a graphics adapter 1112 are coupled to the memory controller hub 1120, and a display 1118 is coupled to the graphics adapter 1112. A storage device 1108, an input interface 1114, and a network adapter 1116 are coupled to the I/O controller hub 1122. Other embodiments of the computing device 1100 have different architectures.

The storage device 1108 is a non-transitory computer-readable storage medium such as a hard drive, compact disc read-only memory (CD-ROM), DVD, or a solid-state memory device. The memory 1106 holds instructions and data used by the processor 1102. The input interface 1114 is a touch-screen interface, a mouse, trackball, or other types of input interface, a keyboard 1110, or some combination thereof, and is used to input data into the computing device 1100. In some embodiments, the computing device 1100 may be configured to receive input (e.g., commands) from the input interface 1114 via gestures from the user. The graphics adapter 1112 displays images and other information on the display 1118. The network adapter 1116 couples the computing device 1100 to one or more computer networks.

The computing device 1100 is adapted to execute computer program modules for providing functionality described herein. As used herein, the term “module” refers to computer program logic used to provide the specified functionality. Thus, a module may be implemented in hardware, firmware, and/or software. In one embodiment, program modules are stored on the storage device 1108, loaded into the memory 1106, and executed by the processor 1102.

The types of computing devices 1100 may vary from the embodiments described herein. For example, the computing device 1100 may lack some of the components described above, such as graphics adapters 1112, input interface 1114, and displays 1118. In some embodiments, a computing device 1100 may include a processor 1102 for executing instructions stored in a memory 1106.

The methods disclosed herein may be implemented in hardware or software, or a combination of both. In one embodiment, a non-transitory machine-readable storage medium, such as one described above, is provided, the medium comprising a data storage material encoded with machine-readable data which, when using a machine programmed with instructions for using said data, is capable of displaying any of the datasets and execution and results of this disclosure. Such data may be used for a variety of purposes, such as road safety, traffic management, and support for autonomous vehicles, and the like. Embodiments of the methods described above may be implemented in computer programs executing on programmable computers, comprising a processor, a data storage system (including volatile and non-volatile memory and/or storage elements), a graphics adapter, an input interface, a network adapter, at least one input device, and at least one output device. A display is coupled to the graphics adapter. Program code is applied to input data to perform the functions described above and generate output information. The output information is applied to one or more output devices in a known fashion. The computer may be, for example, a personal computer, microcomputer, or workstation of conventional design.

Each program may be implemented in a high-level procedural or object-oriented programming language to communicate with a computer system. However, the programs may be implemented in assembly or machine language, if desired. In any case, the language may be a compiled or interpreted language. Each such computer program is preferably stored on a storage medium or device (e.g., ROM or magnetic diskette) readable by a general or special purpose programmable computer, for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner to perform the functions described herein.

The databases thereof may be provided in a variety of media to facilitate their use. The databases of the present disclosure may be recorded on computer-readable media, e.g., any medium that may be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of the skills in the art may readily appreciate how any of the presently known computer-readable mediums may be used to create a manufacturing process comprising a recording of the present database information. “Recorded” refers to a process for storing information on a computer-readable medium, using any such methods as known in the art. Any convenient data storage structure may be chosen, based on the means used to access the stored information. A variety of data processor programs and formats may be used for storage, e.g., word processing text file, database format, etc.

What is claimed is:

1. A system for providing real-time broadcast of signal phase and timing (SPaT) data, comprising:
one or more server processors;
memories, coupled to the one or more processors, configured to store executable instructions that, when executed by the one or more server processors, cause the one or more server processors to perform operations comprising:
receiving SPaT data from one or more traffic signal controllers in either NTCIP 1202 or SAE J2735 format;
processing the SPaT data by converting the SPaT data into one or more different formats from the NTCIP 1202 or SAE J2735 format, wherein the processing comprises distributing a processing load across a plurality of docker containers using a grouping or clustering algorithm that accounts for a raw data arrival sequence from the traffic signal controllers;
using a third-party security credential management system (SCMS) API, digitally signing and verifying the processed SPaT data using an IEEE 1609.2 protocol;
determining one or more nearest intersections associated with the processed SPaT data based on geolocation data of a client device provided through a cloud-hosted REST-API; and
transmitting the processed SPaT data corresponding to the one or more nearest intersections to the client device in an SAE defined format, wherein the processed SPaT data transmission is implemented over heterogeneous network links through a network comprising one or more of Ethernet, fiber, 5G, LTE, or satellite links,
wherein one or more of the receiving, processing, verification, or transmission is provided by a cloud-hosted scalable publish-subscribe based messaging broker comprising a message queuing telemetry transport (MQTT) broker.

2. The system of claim 1, wherein the SPaT data processing is conducted in a cloud environment.

3. The system of claim 1, wherein the SPaT data processing is conducted on an edge device located proximate to the one or more of the traffic signal controllers.

4. The system of claim 3, wherein raw SPaT data from the one or more traffic signal controllers is transmitted to one or more edge devices via a backbone fiber network for processing within the edge devices.

5. The system of claim 3, wherein the edge device relays the processed SPaT data to the client device via an MQTT broker hosted on a cloud server.

6. The system of claim 5, wherein the edge device communicates with the cloud server via one or more of fiber communication or cellular communication.

7. The system of claim 5, wherein a specific instance of the cloud server responsible for relaying communication between the edge device and the client device is automatically selected based on proximity to the edge device.

8. The system of claim 1, wherein the SPaT data processing is conducted on a multiprocessor server within an agency network.

9. The system of claim 3, wherein the edge device includes at least one processor, a memory, a storage, and a 5G, LTE cellular modem to enable real-time SPaT data processing and communication with the traffic signal controllers and the client device.

10. The system of claim 1, wherein a docker container is configured to process SPaT data from one or more intersections.

11. The system of claim 1, wherein a docker container establishes an end-to-end TCP connection with the MQTT broker running on a cloud server.

12. The system of claim 11, wherein the TCP connection with the MQTT broker uses a transport layer security (TLS) mechanism for encrypted communication.

13. The system of claim 11, wherein the TCP connection with the MQTT broker enable low-latency, real-time communication for SPaT data transfer by disabling Nagle's algorithm.

14. The system of claim 1, wherein the processed SPaT data is transmitted to the client device through the MQTT broker.

15. The system of claim 1, wherein the MQTT broker is optionally to be hosted on a mobile edge computing (MEC) platform owned by a cellular operator, and is optionally to be hosted on a cloud server or other non-MEC infrastructure, allowing for flexible deployment and scalability without reliance on cellular operator infrastructure.

16. The system of claim 1, wherein the client device establishes an end-to-end TCP connection with the MQTT broker running on a cloud server to enable the client device to receive the processed SPaT data from the traffic signal controllers.

17. The system of claim 16, wherein the end-to-end TCP connection uses a TLS mechanism to encrypt the SPaT data.

18. The system of claim 16, wherein the end-to-end TCP connection provides low-latency and real-time communication for the processed SPaT data transmitted to the client device by disabling Nagle's algorithm.

19. The system of claim 16, wherein the client device minimizes latency in data transmission by dynamically selecting a nearest available MQTT broker based on proximity to the client device.

20. The system of claim 1, wherein the system uses fiber communication for signal transmission and 5G-enabled client devices for high-speed data reception to achieve an average end-to-end latency of less than 30 ms for SPaT data communication between the signal controller and the client device.

21. The system of claim 1, wherein the system is configured to achieve an average end-to-end latency of less than 50 ms for SPaT data communication between the signal controller and the client device, even when the signal controller is not connected to fiber, by utilizing alternative communication technologies to minimize latency.

22. The system of claim 1, wherein the system is configured to minimize average end-to-end latency for SPaT data communication between the traffic signal controllers and the client device, with latency minimized through use of fiber communication and 5G-enabled client devices for high-speed data reception.

23. The system of claim 1, wherein the system is configured to minimize average end-to-end latency for SPaT data communication between the traffic signal controllers and the client device, with latency minimized when fiber communication is unavailable, and the system operates with alternative network protocols.

24. The system of claim 1, wherein a processing capacity of the plurality of docker containers is scalable to handle a large number of traffic signals in real-time.

25. The system of claim 24, wherein the large number of traffic signals includes more than one thousand, more than ten thousand, or more than one hundred thousand traffic signals.

26. The system of claim 1, wherein an original format of the SPaT data received from the traffic signal controllers comprises the NTCIP 1202 format and one or more different formats including the SAE J2735 format.

27. The system of claim 26, wherein processing the SPaT data comprises decoding the SPaT data in the NTCIP 1202 format with a decoder, and subsequently encoding the decoded data into the SAE J2735 format with an encoder.

28. The system of claim 1, wherein the one or more nearest intersections are identified using a geohashing method.

29. The system of claim 1, wherein transmitting the processed SPaT data corresponding to the one or more nearest intersections comprises presenting the processed SPaT data to the client device through a REST API interface.

30. The system of claim 29, wherein transmitting the processed SPaT data further comprises generating one or more virtual signs for presentation to the client device via the REST API interface.

31. The system of claim 1, wherein the system is configured to integrate with third-party security credential management services (SCMS) to authenticate V2X messages by generating and validating digital signatures in compliance with the IEEE 1609.2 protocol for secure communication.

32. The system of claim 31, wherein each end device involved in TCP communication with the MQTT broker, including an edge device, an agency server with an agency network, and the client device, further comprises a local agent that implements the IEEE 1609.2 protocol for secure communication and interacts with an SCMS API hosted within a local machine to authenticate the V2X messages through the digital signatures.

33. The system of claim 32, wherein the local agent on the edge device interacts with the SCMS API to authenticate the V2X messages in compliance with the IEEE 1609.2 protocol to ensure that each SPaT message received from a traffic signal controller is valid and originates from an authorized source.

34. The system of claim 32, wherein the local agent on the agency server within the agency network interacts with the SCMS API to validate the digital signatures for the V2X messages and ensure compliance with the IEEE 1609.2 protocol to prevent transmission of unauthorized or tampered data to the MQTT broker.

35. The system of claim 32, wherein the local agent on the client device performs digital signature validation on the processed SPaT data received via the MQTT broker and interacts with the SCMS API to authenticate the V2X messages in compliance with the IEEE 1609.2 protocol before presenting to an end user.

36. The system of claim 1, wherein the system is configured to implement an assured green time mechanism for coordinated phases in semi-actuated traffic control environments by configuring one or more traffic signal controllers to operate in a yield coordination mode with coordinated phases set to a rest-in-walk approach, wherein a pedestrian clearance interval occurring before a coordinated phase termination provides a guaranteed assured green period during which vehicular signals maintain green indication.

37. The system of claim 36, wherein an assured green time comprises a fixed pedestrian clearance duration of approximately 6-7 seconds during which the processed SPaT data transmitted to the client device includes countdown timing information representing a guaranteed remaining green time.

38. The system of claim 36, wherein the assured green time mechanism enables red light violation warning applications by providing connected vehicles with advance knowledge of a minimum guaranteed green duration through the processed SPaT data.

39. The system of claim 36, wherein the SPaT data processing includes incorporating assured remaining green interval time values derived from the pedestrian clearance interval into SAE J2735 format messages for transmission to the client device.

40. A computer-implemented method for providing real-time broadcast of signal phase and timing (SPaT) data, comprising:
receiving SPaT data from one or more traffic signal controllers in either NTCIP 1202 or SAE J2735 format;
processing the SPaT data by converting the SPaT data into one or more different formats, wherein the processing includes distributing a processing load across a plurality of docker containers using a grouping or clustering algorithm that accounts for a raw data arrival sequence from the traffic signal controllers;
digitally signing and verifying the processed data using third-party security credential management system (SCMS) API leveraging IEEE 1609.2 protocol;
determining one or more nearest intersections based on geolocation data of a client device through a cloud-hosted REST-API; and
transmitting the processed SPaT data corresponding to the one or more nearest intersections to the client device in an SAE defined format, wherein data transmission is implemented over heterogeneous network links through a network including one or more of Ethernet, fiber, 5G, LTE, or satellite links,
wherein a cloud-hosted scalable publish-subscribe based messaging broker including a message queuing telemetry transport (MQTT) broker is leveraged in one or more of data receiving, processing, verification, or transmission.

41. The method of claim 40, further comprising implementing an assured green time mechanism by configuring traffic signal controllers to operate in a yield coordination with a rest-in-walk configuration, wherein pedestrian clearance intervals provide guaranteed assured green periods that are incorporated into the processed SPaT data.
